(19) United States
(12) Patent Application Publication
(10) Pub. No.: US 2002/0069106 A1
(43) Pub. Date: Jun. 6, 2002

(54) Method and apparatus for providing interactive management of branded multimedia content and advertising

(76) Inventor: Noah Shalom Shopsowitz, Toronto (CA)

Correspondence Address: Stephen J. Perry, SIM & McBURNEY, 6th Floor, 330 University Avenue, Toronto, ON, M5G 1R7, CA

(21) Appl. No.: 09/729,783

(22) Filed: Dec. 6, 2000

(51) Int. Cl. G06F 17/60

(52) U.S. Cl. 705/14

(57) ABSTRACT

A method of providing interactive management of branded multimedia content and advertising content at a location accessible to a consumer having redeemable credit, comprising the steps of providing a multimedia terminal at the location for receiving the multimedia content and the advertising content, presenting the advertising content and, in response to the consumer redeeming the credit at the terminal, presenting the multimedia content to the consumer, providing a first remuneration for the multimedia content based on the presenting of the multimedia content to the consumer via the multimedia terminal, providing a second remuneration for the advertising whereby the second remuneration at least partially offsets the first remuneration.

### FIELD OF THE INVENTION

The present invention relates generally to vending branded multimedia content, and more particularly to a system and method for providing multimedia content to consumers via a multimedia vending device.

### BACKGROUND OF THE INVENTION

The term “branded multimedia content”, as used in this specification, means any form of media which is not advertising, that has reached or is intended to reach a high level of recognition across a broad demographic population.

Beginning in the mid-to-late 1980s, customer loyalty programs and cross brand leveraging have played increasingly important roles in the retailing of goods and services. For example, car manufacturers, book and CD retailers, airlines, and fast food franchises, to name but a few providers of retail goods and services, have used reward programs for enhancing brand loyalty among consumers. It will be understood that retailing includes traditional modes of retailing (e.g. stores and catalogues, etc.) as well as electronic (i.e. e-commerce) retailing. Specialized reward programs have also been implemented for cross-leveraging participant retailers' products. One example of such a reward program is the Air Miles® program of Loyalty Management in Canada, by which consumers are rewarded with “points” for purchasing goods and services from participating vendors. Once a sufficient number of “points” have been collected, the consumer may redeem them in the form of goods and services offered by other participating vendors. Other such programs are offered by companies such as Diner's Club/EnRoute®, AT&T®, Sears®, and Cineplex Odeon. Additionally, reward programs have been developed whereby consumers are presented on-line with an invoice for payment and wherein the consumers are rewarded with early payment.

Traditional advertising media (e.g. Magazines, TV, radio, etc.) integrates editorial content and advertising content, thereby increasing the value as, perceived by the consumer. New media (e.g. HTML, VRML, etc.) provides an opportunity to further integrate editorial and advertising content to enhance the value to the consumer, as set forth in greater detail below.

### SUMMARY OF THE INVENTION

According to the present invention, a method and apparatus are provided for leveraging sales of products and services by means of a consumer reward redemption system using multimedia terminals located in public spaces. A multimedia content provider supplies content to the terminals which can be viewed by a consumer upon redemption of reward points accumulated through the purchase of goods and services. Preferably, user authentication and points redemption is performed at the terminal in response to the consumer inserting a magnetic or smart card into a card reader forming part of the terminal. The manager or owner of the location in which the terminal is located (e.g. retailer, airport lounge, service station, etc.) pays a royalty to the content provider (e.g. brand licensor) based on consumer usage of the multimedia content. Suppliers can provide advertising content for presentation on the terminal in connection with which the manager or owner of the location (i.e. operator of the terminal) is remunerated. The advertising is provided to stimulate further sales to consumers who, in turn, are rewarded with additional points that can be redeemed at the terminal.

### BRIEF DESCRIPTION OF THE DRAWINGS

A preferred embodiment of the present invention will now be described more fully with reference to the accompanying drawings in which:

FIG. 1 is a block diagram of a business model for providing multimedia content to consumers according to the present invention;

FIG. 2 is flowchart showing a method of providing multimedia content to consumers according to the model of FIG. 1;

FIG. 3 is a block diagram of the functional components of hardware for implementing the model and implementation method of FIGS. 1 and 2; and

FIG. 4 shows an exemplary Graphical User Interface (GUI) for display on a multimedia terminal forming part of the.

### DETAILED DESCRIPTION OF THE PREFERRED EMBODIMENT

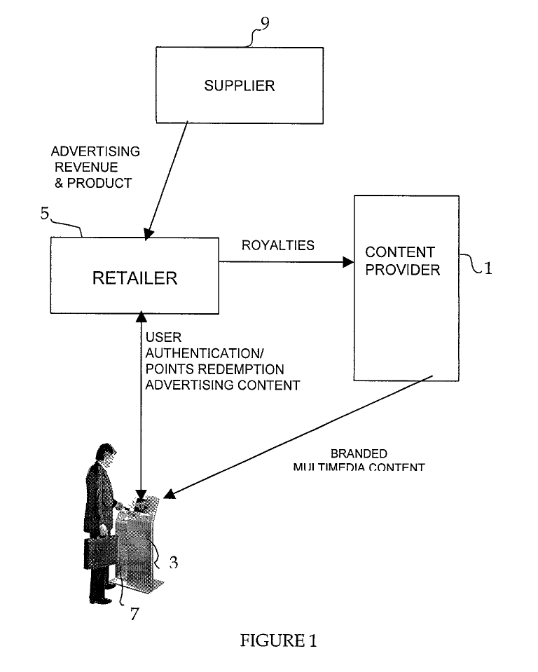

With reference to FIG. 1, a block diagram is provided of a business model for providing multimedia content to a consumer in a public setting (e.g. store, theatre, airport, pay telephone, service station, restaurant, etc.) A content provider 1 creates original branded multimedia content (e.g. videos, audio, art, pictures, cartoons, interactive video games, web sites, television programming, on-line books or magazines, etc.) which may be played on a multimedia terminal 3 located in the public setting. The operator of the public setting (e.g. a retailer 5) pays a royalty to the content provider for the use of the multimedia content. A consumer who participates in a loyalty or reward program at the retail setting is awarded credit for purchases made. This credit information is stored either on a magnetic stripped card 7, smart card, or stored on a central database, and can be redeemed within the terminal 3 in the form of access to multimedia content. Although not illustrated, the loyalty reward administrator is usually connected to the terminal 3 for validating credit information on the card 7. It is also contemplated that the multimedia content may be emailed to the consumer or reproduced onto a readable media (e.g. DVD or CD-ROM) and dispensed to the consumer via the terminal 3.

For example, in the scenario where the retail setting is a grocery store, a parent can insert his or her card 7 containing the credit information into the terminal 3 (or, for an implementation without card reader, enters a PIN number) to redeem multimedia content (e.g. cartoons created by Disney) for entertaining accompanying children while the parent is shopping for groceries. Once the appropriate multimedia content has been selected and a time interval chosen for presentation of the content (e.g. 30 minutes), the user withdraws his or her card 7 and goes about the task of shopping for groceries while the children are otherwise entertained. Upon check-out, the customer again presents the loyalty card 7 to the check-out clerk in order to have credit added for his or her purchases.

In order to offset the cost of the multimedia terminal 3 and royalties, it is contemplated that advertising may be presented at the multimedia terminal 3 (preferably while the terminal 3 is not being used by a consumer to redeem reward points) for which the retailer 5 is compensated by the supplier 9 whose product or service is being advertised. Returning to the grocery store example, it is contemplated that, as an alternative or adjunct to customary point of sale advertising (posters, displays, etc.), a manufacturer, distributor or supplier 9 (e.g. Kraft Foods) advertises its product via the terminal 3 and pays the retailer 5 for the opportunity to advertise at the retail setting (e.g. grocery store). The grocery store, in tun, pays royalties to the content provider 1 (e.g. Disney).

It is also contemplated that, to further leverage the brand strategy potential for the present invention, the supplier 9 (e.g. a clothing manufacturer) may use trademarks, logos, images, etc. under license from the content provider 1 (e.g. Disney) in addition to merely advertising on the terminal 3 used to present the content provider's media.

As an alternative to the distributed arrangement of FIG. 1, it is further contemplated that a content “aggregator” may collect advertising content, video, HTML content, etc., and package the collected content for display on terminal 3 at the premises of retailer 5 or other premises.

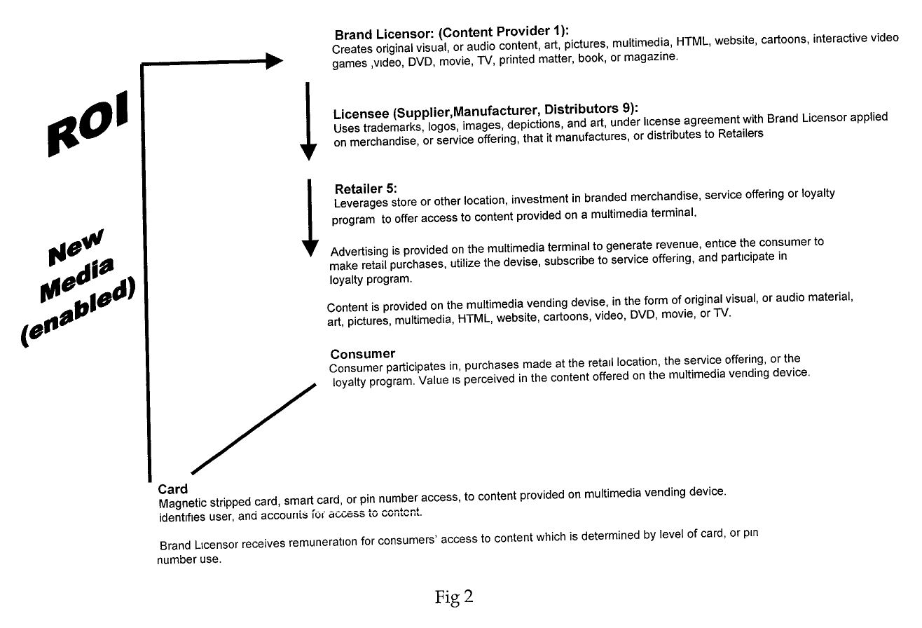

Turning to FIG. 2, a flowchart is provided showing the steps of providing multimedia content to consumers via redemption of points earned through purchases of merchandise, use of a service or participation in a loyalty program which may include on-line presentation of bill payment, as discussed above, in accordance with the present invention. First, the content provider 1 (or brand licensor) creates an original multimedia presentation. The content provider 1 then licenses the use of trademarks, logos, artwork, etc. to a supplier 9 (licensee), who is typically a manufacturer or distributor. The retailer 5 is thus able to leverages the following things at store locations or other locations: investment in branded merchandise, service offerings, or loyalty programs to offer consumers access to content via the multimedia terminal 3. The terminal 3 displays both the multimedia content created by the provider 1 and advertising of the merchandise, services offerings, etc. of the supplier, manufacturer or distributor 9. This advertising supports the sale, of goods to the consumer, generates revenue for the retailer 5, and entices the consumer to make further retail purchases or subscribe to the supplier's service offering and participate in the loyalty program. The content provider receives a return on investment in the form of royalties for consumers' access to the multimedia content.

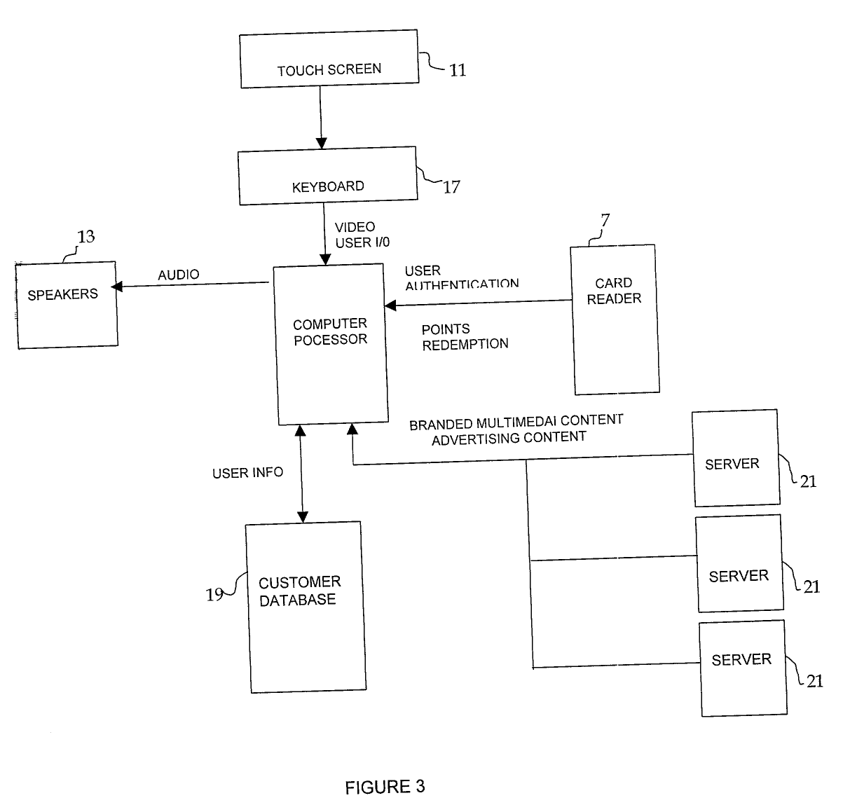

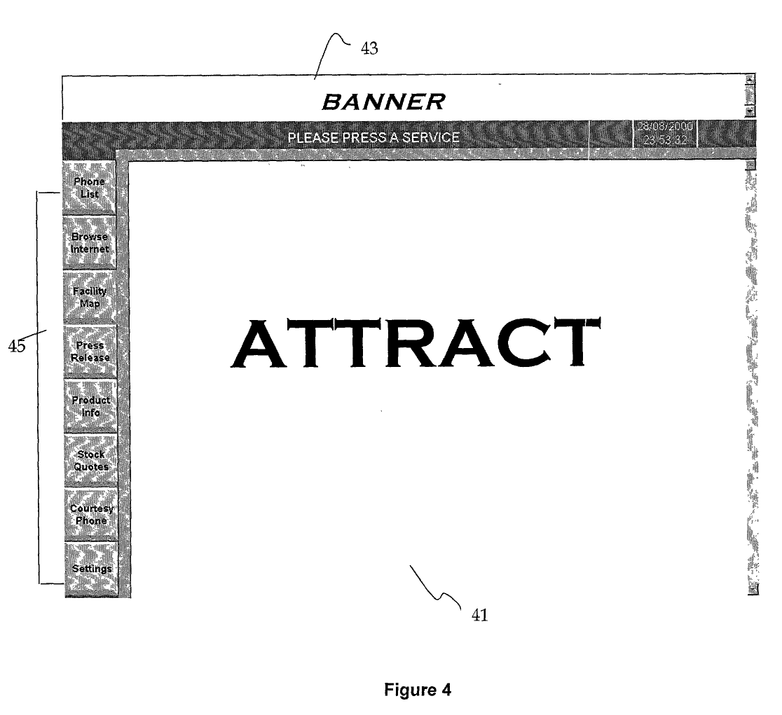

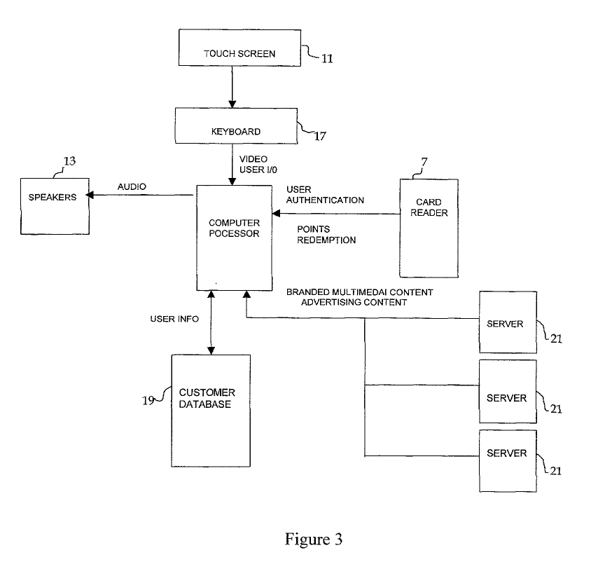

The functional aspects of multimedia terminal 3, are shown in greater detail with reference to FIG. 3. A touchscreen 11 (e.g. AMLCD or plasma screen) and speakers are provided for presenting the multimedia content and advertising to the consumer. A card reader 15 is provided for receiving the consumer's magnetic or “smart” card. Upon inserting the card, the terminal typically requests entry of a user PIN via touchscreen 11, in a well known manner. The user enters this information either via a separate keyboard 17 or through the touch sensitive functionality of the touchscreen 11. The user's PIN is verified and data regarding the extent of the user's redeemable points and other appropriate customer account information are downloaded to the terminal 3 from a customer database 19 (which may be located in the terminal 3 or accessed via secure connection to a remote location). Content and advertising may be downloaded to the terminal 3 via ISDN, DSL, modem or other signal pipeline from servers 21.

The structure and operation of the hardware depicted in FIG. 3 will be well known to a person of ordinary skill in the art. One example of such a system is the Plynth multimedia terminal manufactured by King Products Inc. Communications between the terminal 3 at retailer 5 or elsewhere, content provider 1, loyalty reward administrator (not shown), etc., are preferably managed by a suitable network communications protocol, such as provided by the King.net software of King Products Inc.

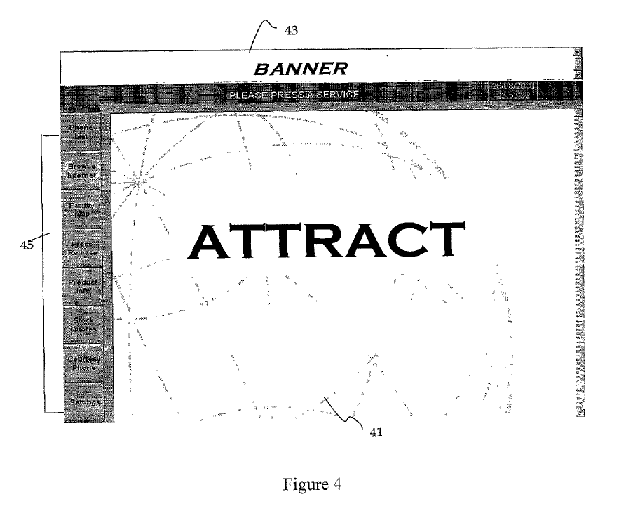

The exemplary Graphical User Interface (GUI) of FIG. 4 includes a central attract screen area 41 for display of HTML web pages having embedded hypertext links, windowed or full-screen video, etc., which is bounded by banner advertising 43 along the top of the central display area and by specialty buttons 45 along the left (e.g. phone list, browse Internet, facility map, etc.).

In summary, a business model is presented for brand interaction management along with an implementation of the model by which consumers, retailers, suppliers and content providers exchange consideration in the form of licensing royalties, advertising revenue, loyalty reward points, etc. This creates a highly-leveraged interactive multimedia experience for the consumer, integrating advertising with a wide range of valuable content.

Alternatives and variations of the invention are possible. All such embodiments, modifications and applications are believed to be within the sphere and scope of the invention as defined by the claims appended hereto.

I claim:

1. A method of providing interactive management of branded multimedia content and advertising content at a location accessible to a consumer having redeemable credit, comprising the steps of:
providing a multimedia terminal at said location for receiving said multimedia content and said advertising content, presenting said advertising content and, in response to said consumer redeeming said credit at said terminal, presenting said multimedia content to said consumer;
providing a first remuneration for said multimedia content based said presenting of said multimedia content to said consumer via said multimedia terminal; and
providing a second remuneration for said advertising whereby said second remuneration at least partially offsets said first remuneration.

2. A system of providing interactive management of branded multimedia content created by a content provider and advertising content from a supplier at a location managed by an entity and accessible to a consumer having redeemable credit, comprising:
a loyalty mechanism for rewarding said consumer with said redeemable credit for participation in a loyalty program and for tracking redemption of said credit; and
a multimedia terminal at said location for presenting said advertising content in consequence whereof said supplier remunerates said entity, and for permitting said consumer to redeem said credit in exchange for presentation of said multimedia content to said consumer in consequence whereof said operator remunerates said source of multimedia content.

3. The system of claim 2, wherein said multimedia terminal further comprises a first input for receiving said redeemable credit from said loyalty mechanism, a display and speakers for presenting said advertising content and said multimedia content, and a further input for receiving said advertising content and said multimedia content.

4. The system of claim 3, wherein said loyalty mechanism includes a customer database accessible via at least one of a magnetic stripped card, smart card or PIN for said consumer.

5. The system of claim 2, wherein said branded multimedia content includes at least one of videos, audio, art, pictures, cartoons, interactive video games, web sites, television programming, on-line books or magazines.

6. The method of claim 1 wherein said location of said terminal and said branded multimedia content are selected to optimize perceived value to said consumer.

7. The system of claim 2 wherein said location of said terminal and said branded multimedia content are selected to optimize perceived value to said consumer.
